(19) United States
(12) Patent Application Publication
(10) Pub. No.: US 2025/0046825 A1
(43) Pub. Date: Feb. 6, 2025

(54) Electrode and Electrochemical Cell

(71) Applicant: Ceres Intellectual Property Company Limited, Horsham West Sussex (GB)

(72) Inventors: Robert Leah, Horsham West Sussex (GB); Mahfujur Rahman, Horsham West Sussex (GB)

(21) Appl. No.: 18/697,358

(22) PCT Filed: Sep. 29, 2022
(86) PCT No.: PCT/GB2022/052479

§ 371 Date: Mar. 29, 2024

(30) Foreign Application Priority Data
Sep. 30, 2021 (GB) 2114064.5
Sep. 30, 2021 (GB) 2114065.2

(51) Int. Cl. H01M 4/90; C01F 17/224; C25B 11/077; C25B 13/07; G01N 27/30; H01M 4/86; H01M 8/12; H01M 8/1253

(52) U.S. Cl. CPC H01M 4/9033; C01F 17/224; C25B 11/0773; C25B 13/07; G01N 27/304; H01M 4/8621; H01M 8/1253; C01P 2002/54; C01P 2002/72; C01P 2004/03; C01P 2006/40; H01M 2004/8689; H01M 2008/1293; H01M 2300/0077

(57) ABSTRACT

An electrode for an electrochemical cell is disclosed which has a first layer containing a first electrode material of formula Pr₍₁₋ₓ₎LnₓO_{(2-0.5x-δ)}. Ln is selected from at least one rare earth metal, 8 is the degree of oxygen deficiency, and 0.01≤x≤0.4. The rare earth metal may be a lanthanide, scandium or yttrium. Also disclosed is an electrochemical cell having such an electrode and methods of making such an electrochemical cell. The electrochemical cell may be an electrolytic cell, an oxygen separator, a sensor or a fuel cell. Also disclosed are materials of formula Pr₍₁₋ₓ₎LnₓO_{(2-0.5x-δ)} and Pr₍₁₋ₓ₎SmₓO_{(2-0.5x-δ)}.

### CROSS REFERENCE TO RELATED APPLICATIONS

The present application is a § 371 national stage of international application no. PCT/GB2022/052479, filed on Sep. 29, 2022, which claims priority to UK application no. 2114065.2, filed on Sep. 30, 2021, and claims priority to UK application no. 2114064.5, filed on Sep. 30, 2021, the entire contents of all of which are incorporated by reference herein.

### FIELD

The present invention relates to electrodes for electrochemical cells, to electrochemical cells comprising such electrodes, to methods of producing such electrochemical cells and to materials for use in such electrodes.

### BACKGROUND

Electrochemical cells formed of oxide layers (often known as solid oxide cells: SOC) may be used as fuel cells or electrolyser cells.

SOC fuel cell units produce electricity using an electrochemical conversion process that oxidises fuel. SOC fuel cell units can also, or instead, operate as regenerative fuel cells (or reverse fuel cells) units, often known as solid oxide electrolyser fuel cell units, for example to separate hydrogen and oxygen from water, or carbon monoxide and oxygen from carbon dioxide.

A solid oxide fuel cell (SOFC) generates electrical energy through the electrochemical oxidation of a fuel gas (usually hydrogen-based) and the device is generally ceramic-based, using an oxygen-ion conducting metal-oxide containing ceramic as its electrolyte. Many ceramic oxygen ion conductors (for instance, doped zirconium oxide or doped cerium oxide) have useful ion conductivities at temperatures in excess of 500° C. (for cerium-oxide based electrolytes) or 650° C. (for zirconium oxide-based ceramics), so SOFCs tend to operate at elevated temperatures.

In operation, the electrolyte of the SOFC conducts oxygen ions from a cathode to an anode located on opposite sides of the electrolyte. A fuel, for example, a fuel derived from the reforming of a hydrocarbon or alcohol, contacts the anode (usually known as the “fuel electrode”) and an oxidant, such as air or an oxygen rich fluid, contacts the cathode (usually known as the “air electrode”). Conventional ceramic-supported (e.g. anode-supported) SOFCs have low mechanical strength and are vulnerable to fracture. Hence, metal-supported SOFCs have recently been developed which have the active fuel cell component layers supported on a metal substrate. In these cells, the ceramic layers can be very thin since they only perform an electrochemical function: that is to say, the ceramic layers are not self-supporting but rather are thin coatings/films laid down on and supported by the metal substrate. Such metal supported SOFC stacks are more robust, lower cost, have better thermal properties than ceramic-supported SOFCs and can be sealed using conventional metal welding techniques.

Applicant's earlier patent application WO-A-2015/136295 discloses metal-supported SOFCs in which the electrochemically active layer (or active fuel cell component layer) comprises anode, electrolyte and cathode layers respectively deposited (e.g. as thin coatings/films) on and supported by a metal support plate (e.g. foil). The metal support plate has a porous region surrounded by a non-porous region with the active layers being deposited upon the porous region so that gases may pass through the pores from one side of the metal support plate to the opposite side to access the active layers coated thereon. The porous region comprises small apertures (holes drilled through the metal foil substrate) extending through the support plate, overlying the anode (or cathode, depending on the orientation of the electrochemically active layers).

A solid oxide electrolyser cell (SOEC) may have the same structure as an SOFC but is in practice an SOFC operating in reverse, or in a regenerative mode, to achieve the electrolysis of water and/or carbon dioxide.

The fuel electrode, electrolyte and air electrode of an SOC may each be formed of one or more layers to optimise operation. Effective air electrode materials allow diffusion of oxygen to the air electrode/electrolyte interface and have a similar thermal expansion coefficient to the electrolyte. Practical air electrode materials often have the perovskite structure ABX₃, where A and B are different metal ions (there can be more than one A and B metal ion), X may be O. The air electrode in some SOFCs may be formed of an active layer close to the electrolyte which has high activity for electrochemical reduction of oxygen and a bulk layer which may be a metallic conductor. There are a number of known cathode materials.

Cruz Pacheco et al., (J. Phys: Conference Series, vol. 687, no. 1, 2016) disclose synthesis of praseodymium doped cerium oxides by the polymerization combustion method for application as anodic components in SOFC devices.

Doped praseodymium oxides have been investigated for reasons unrelated to SOCs. For example, Zoellner et al. (J. Crystal Growth, vol. 355, no. 1, 2012, p. 159-165) disclose the stoichiometry-structure correlation of epitaxial cerium doped praseodymium oxide films on Si (111). Knauth et al. (J. European Ceramic Society, vol. 19, no. 6-7, 1999, p. 831-836) disclose non-stoichiometry and relaxation kinetics of nanocrystalline mixed praseodymium-cerium oxide. Popescu Ione et al. (Applied Catalysis A: General, vol. 578, 2019, p. 30-39) disclose studies on the catalytic oxidation performances of Ce—Pr mixed oxides. Simona Somacescu et al. (J. Nanoparticle Research; vol. 14, no. 6, 2012, p. 1-17) disclose CePrO structure, morphology, surface chemistry, and catalytic performance. Kang et al. (J. Alloys and Compounds, vol. 207-208, 1994, p. 420-423) disclose structures and structural defects in colloidal particles altered in situ in HREM.

U.S. Pat. No. 6,117,582 describes a cathode composition for a solid oxide fuel cell having a cathode made from a transition metal perovskite, such as PrCoO₃, or praseodymium manganite. Nicollet, C, et al., International Journal of Hydrogen Energy, September 2016, Vol. 41, Issue 34, pages 15538-15544, describes Pr₆O₁₁ as an electrocatalyst for the oxygen reduction reaction and its use as a cathode in a SOFC. CN-A-106 057 641 discloses La, Nd and Gd doped Pr semiconductor oxides. Wang et al 2017 Meet. Abstr. (MA2017-02) 1730 discloses Pr₁₋ₓNdₓO_{2-d} combined with (Pr,Nd)₂NiO₄ (PNNO) to improve the activity and phase stability of PNNO used as the cathode for solid oxide fuel cells. Biswas, R. et al. (1997) Journal of Materials Science Letters. 16. 1089-1091 discloses the preparation, structure and electrical conductivity of Pr₁₋ₓLaₓO_{2-δ} (x=0.05, 0.1, 0.2). Zhu, et al. Advanced Materials Research, vol. 1065-1069, (2014), pp. 1921-1925 discloses the preparation and properties of Ce_{0.8}Pr_{0.2-x}NdₓO_{2-δ} (x=0.02, 0.05, 0.1). WO-A-2006/106334 A1 describes a solid oxide fuel cell (SOFC) wherein the cathode material includes a doped material, having a perovskite structure, which may include praseodymium. This structure has the conventional notation ABX₃, wherein cerium is substituted onto the “B” site.

There is still a need, however, to provide electrode materials that have suitable properties for use in electrochemical cells.

It is an aim of the present invention to address such a need.

### SUMMARY

The present invention accordingly provides, in a first aspect, an electrode for an electrochemical cell, the electrode comprising at least a first layer comprising a first electrode material of formula Pr₍₁₋ₓ₎LnₓO_{(2-0.5x-δ)}, wherein Ln is selected from at least one rare earth metal, δ is the degree of oxygen deficiency, and 0.01≤x≤0.4.

δ may vary depending on the environment and history of the first electrode material. In an oxidising environment in many praseodymium-containing oxides, praseodymium is in a thermodynamic equilibrium between its +3 and +4 oxidation states, dependent upon the temperature and oxygen partial pressure. When Pr⁴⁺ is reduced to Pr³⁺ an oxygen vacancy is created. Oxygen vacancies induced by praseodymium reduction are known as extrinsic vacancies. Using Kröger-Vink notation, the equilibrium may be expressed as:

$$P {r}^{4 +} + O o ↔ {Pr}^{3 +} + Vo \text{"+0.5} {O}_{2} ( g )$$

where Vo″ is an oxygen vacancy.

In the first electrode material, δ may be 0.25 or lower, suitably 0.2 or lower and more suitably ≤0.15.

δ may have a lower limit of 0.0001, optionally 0.001, optionally 0.005, optionally 0.01, optionally 0.05.

The addition of (e.g. trivalent) dopant cations to praseodymium oxide creates intrinsic oxygen vacancies in the structure. In the first electrode material, suitably the rare earth metal may act as a dopant.

The rare earth metal may be selected from a lanthanoid, Sc, Y and mixtures thereof.

Suitably, the rare earth metal is not cerium.

Suitably, the rare earth metal may be selected from La, Nd, Sm, Eu, Gd, Tb, Dy, Ho, Er, Tm, Yb, Lu, Sc, Y and mixtures thereof.

More suitably, the rare earth metal may be selected from La, Nd, Sm, Eu, Gd, Dy, Ho, Er, Tm, Yb, Lu, Sc, Y and mixtures thereof.

Most suitably, the rare earth metal may be selected from La, Nd, Sm, Eu, Gd, and Yb; preferably Nd, Sm, Eu, Gd, more preferably Gd or Sm, most preferably Sm.

As used in this specification, Ln indicates a dopant and thus Ln excludes Pr.

The oxides of praseodymium represent a system of phases whose composition is somewhat variable. Single phase PrO₂ generally forms in pure oxygen and at elevated pressure (>20,000 kPa). Among the different oxides, Pr₆O₁₁ is particularly stable. At ambient temperatures and pressure, Pr₆O₁₁ adopts a cubic fluorite structure with the praseodymium ions in Pr₆O₁₁ being in a mixed valency state of Pr(III) and Pr(IV) with extrinsic oxygen vacancies, facilitating oxygen ion conductivity and are thought (without wishing to be bound) to provide catalytic activity.

Advantageously, the presence of a rare earth metal dopant in the first electrode material may result in the formation of additional, intrinsic, oxygen vacancies and may stabilise the cubic fluorite structure of the material.

Suitably, the ionic radius of Ln may be similar to the ionic radius of praseodymium (IV). This is advantageous because it may reduce the lattice strain and result in a more stable structure. The ionic radius of Pr(IV) (8-coordinate) is 110 picometres.

Thus, as discussed herein particularly suitable rare earth include La, Nd, Sm, Eu, and Gd, or mixtures thereof. The ionic radii of selected Ln (III) are shown in table 1, below.

TABLE 1

| Element | M(III)Trivalent ionic radius/pm |
|---|---|
| Neodymium (Nd) | 112.3 |
| Samarium (Sm) | 109.8 |
| Europium (Eu) | 108.7 |
| Gadolinium (Gd) | 107.8 |

In the first electrode material, x may be selected to achieve a balance between oxygen vacancy concentration and ion-mobility e.g. 0.02 to 0.25. Advantageously, x may be in the range 0.02≤x≤0.3; 0.03≤x≤0.3; 0.04≤x≤0.3; 0.05≤x≤0.3; 0.05≤x≤0.27; 0.05≤x≤0.25; 0.05≤x≤0.25; or 0.05≤x≤0.3. Suitably, x may be from 0.08 to 0.2 or 0.08 to 0.12, more suitably x may be about 0.1; about 0.15; or about 0.2.

Thus, suitably the first electrode material may be of formula Pr_{0.9}Ln_{0.1}O_{(1.95-δ)}, Pr_{0.85}Ln_{0.15}O_{(1.925-δ)}, Pr_{0.8}Ln_{0.2}O_{(1.9-δ)} or mixtures thereof, wherein Ln is La, Nd, Sm, Eu, Gd, or Yb; preferably Sm.

The first layer of the electrode may consist essentially of the first electrode material. Optionally, the first layer may comprise a composite layer comprising the first electrode material and at least one further material. The further material may comprise, for example, doped ceria or doped zirconia or mixtures thereof. Doped ceria may comprise cerium gadolinium oxide (CGO). Doped zirconia may be a solid solution which conforms to the formula Zr₍₁₋ₓ₎YₓO_{(2-0.5xδ)} where 0<x≤0.2.

Thus, the first layer may comprise 20% by weight or greater of the first electrode material; optionally 25% by weight or greater of the first electrode material; optionally 30% by weight or greater of the first electrode material; optionally 35% by weight or greater of the first electrode material; optionally 40% by weight or greater of the first electrode material; optionally 45% by weight or greater of the first electrode material; optionally 50% by weight or greater of the first electrode material; optionally 55% by weight or greater of the first electrode material; optionally 60% by weight or greater of the first electrode material.

Alternatively, the first layer may comprise 80% by weight or greater of the first electrode material; optionally 85% by weight or greater of the first electrode material; optionally 90% by weight or greater of the first electrode material; optionally 95% by weight or greater of the first electrode material.

Advantageously, the first electrode material may have a cubic crystalline structure; preferably a fluorite crystalline structure. Thus, at least one phase of the first electrode material may have a fluorite crystal structure and may have a lattice parameter in the range of a=5.4 to 5.5 Å; and/or may have a crystallite size, for example, of 20 to 85 nm. The first electrode material may essentially comprise or consist of a single phase having a cubic fluorite structure. Such a structure is more stable and may have more predictable oxygen-ion transport properties than a plurality of different phases, each such phase having a different degree of oxygen non-stoichiometry.

The first electrode material may be milled to have a size, doo, in the range 0.5 μm to 1.5 μm. As used herein, d₉₀, d90, d(90) or D90, is the particle diameter such that 90% of the particles in the tested sample are smaller than the doo particle diameter, or the percentage of particles smaller than doo is 90%.

The first electrode material may have a specific surface area (e.g. BET: Brunauer, Emmett, Teller, specific surface area) in the range ≥7 m²/g; suitably greater than 10 m²/g, more suitably greater than 12 m²/g, most suitably 20 m²/g or greater.

The first electrode layer may advantageously have area-specific resistance for oxygen reduction/discharge depending on the direction of current flow of ≤100mΩcm² at 600° C. or <300mΩcm² at 500° C. The activation energy for oxygen reduction/discharge may be in the range of about 100 to 110 kJmol⁻¹.

The first layer may have a thickness in the range 1 μm to 7 μm, optionally 1 μm to 6 μm; 1 μm to 5 μm; 1 to 4 μm or about 3 μm.

The electrode may be a multilayer electrode system which provides additional and/or improved properties for the electrochemical cell. For example, the electrode may be a two-layer, three-layer, four-layer or five-layer system or may have more than five layers. Generally, each layer of the electrode system may be the same or different and, if different, may be formed of different materials and may have different properties and uses in the electrode system as a whole.

Thus, the electrode may comprise at least a second layer comprising a second electrode material. Optionally, the second electrode material may be electrically conductive, optionally may be an electrically conductive ceramic material.

The second layer may have a thickness in the ranges 10 μm to 80 μm; 15 μm to 75 μm; 17 μm to 73 μm; 20 μm to 70 μm; 20 μm to 65 μm; 20 μm to 60 μm; 25 μm to 55 μm; 30 μm to 50 μm; or 35 μm to 45 μm.

The ratio of the thicknesses of the first electrode layer and the second electrode layer may be in the ranges: 1 to 20; suitably 1 to 10, more suitably 1 to 6 and optionally 1 to 5.

In a second aspect, the present invention accordingly provides an electrode for an electrochemical cell, the electrode comprising at least a first layer comprising a first electrode material of formula Pr₍₁₋ₓ₎LnₓO_{(2-0.5x-δ)}, and at least a second layer comprising a second electrode material; wherein Ln is selected from at least one rare earth metal, δ is the degree of oxygen deficiency, and 0.01≤x≤0.4.

As an example, the first and second layers of the electrode system may comprise respectively the first layer as discussed above for use as an air electrode active layer (also known in SOFCs as a cathode active layer CAL), and a second layer as an air electrode bulk layer (also known in SOFCs as a cathode bulk layer CBL). The air electrode bulk layer may have greater electrical (i.e. electron) conductivity than the first layer and may thereby act as a current collector.

The first layer may be situated next to the electrolyte (which itself may be an electrolyte system comprised of multiple layers) with either an intermediate layer (e.g. a further layer of the electrode) between the first layer of the electrode and the electrolyte or wherein the first layer is directly in contact with (i.e. is immediately adjacent to) a layer of the electrolyte.

The second layer (e.g. an air electrode bulk layer) may advantageously be formed of or comprise a second electrode material that is electrically conductive e.g. that may be a metallic conductor at the operating temperature of the electrochemical cell and may have relatively high electronic conductivity at those temperatures. The second layer material is preferably chemically and mechanically stable. The second layer, e.g. the air electrode bulk layer, will usually be porous (as usually will be the first layer) to allow good interaction with oxygen on the air side of the cell. The electrocatalytic activity of the second layer (e.g. air electrode bulk layer) may be less than that of the first layer (which as discussed above may have a high electrocatalytic activity).

The second electrode material may comprise an electronically conductive ceramic material, preferably having a perovskite structure, ABX₃.

Suitable second electrode materials include lanthanum cobaltite, lanthanum ferrite, lanthanum nickel ferrite, La_{0.99}Co_{0.4}Ni_{0.6}O_{(3-δ)} (LCN60) and mixtures thereof.

Optionally, the second layer may be a composite layer further comprising at least one additional second electrode material. The additional electrode material may comprise a strontium containing material, optionally selected from rare earth strontium cobaltite; rare earth strontium ferrite, rare-earth strontium cobalt ferrite; the rare earth component may optionally be Pr, La, Gd and/or Sm, preferably Pr.

A composite second electrode layer may comprise the second electrode material and the additional electrode material in a ratio of between 1:10 to 10:1 by weight, optionally 1:5 to 5:1 by weight, optionally 1:1 to 5:1 by weight. Optionally, a composite second electrode layer may comprise 60% by weight or greater of the second electrode material; optionally 65% by weight or greater of the second electrode material; optionally 70% by weight or greater of the second electrode material; optionally 75% by weight or greater of the second electrode material.

The electrode may further comprise a third layer that may comprise a third electrode material.

To improve adhesion between the first electrode layer and the second electrode layers, if necessary, the third layer may optionally be situated between the first layer and the second layer.

Optionally, the third electrode material may comprise an oxygen ion conductor. The oxygen ion conductor may preferably comprise doped ceria, or doped zirconia or mixtures thereof. The doped ceria may preferably comprise cerium gadolinium oxide (CGO), which is a solid solution having the formula, Ce₍₁₋ₓ₎GdₓO_{(2-0.5x-δ)} where 0<x≤0.5. The doped zirconia may be a solid solution which conforms to the formula Zr₍₁₋ₓ₎YₓO_{(2-0.5xδ)} where 0<x≤0.2.

Additionally or alternatively, the third electrode material may comprise a strontium containing material, optionally selected from rare earth strontium cobaltite; rare earth strontium ferrite, rare-earth strontium cobalt ferrite; wherein the rare earth component may optionally be Pr, La, Gd, and/or Sm; preferably Pr.

Optionally, the third electrode material may comprise a mixed material of rare earth strontium cobaltite or rare earth strontium ferrite and rare-earth doped ceria (REDC). The ratio of such a mixture may be 70:30 by weight, to 30:70 by weight, for example 60:40 by weight rare-earth strontium cobaltite, rare earth strontium ferrite or rare-earth strontium cobalt ferrite to REDC, e.g. 60:40 rare-earth strontium cobaltite to REDC. A particularly suitable third electrode material may comprise 60:40 by weight of a mixture of praseodymium strontium cobaltite (e.g. PSC 551: Pr_{0.5}Sr_{0.5}CoO₃) and CGO.

The third electrode material may promote good adhesion between the first and second electrode layers and may reduce any reaction in the conditions of the cell between the second electrode material (e.g. LCN60) and the first electrode material that may lead to the formation of secondary phases, which may lead to poorer adhesion and potentially increased ohmic resistance.

Furthermore, the third electrode layer may act as a poison getter for the first electrode layer as contaminants in the cell may react with the third electrode material (e.g. containing strontium cobaltite/cobalt ferrite) before contacting the first electrode layer. This advantageously protects the first electrode material and layer from degradation. Such contaminants may include chromium, which tends to evaporate off stainless steel components at higher temperature and react to form a stable chromate phase over the active surface of the air electrode; silicon, which physically blocks the active surfaces of the air electrode; and sulphur from SO₂ in the air, which tends to react to form sulphates.

The third layer may have a thickness in the range 1 μm to 5 μm; 1 μm to 4 μm; 2 μm to 5 μm; or 2 μm to 4 μm.

Thus, the electrode may advantageously comprise a first layer comprising a first electrode material of formula Pr₍₁₋ₓ₎LnₓO_{(2-0.5x-δ)}, and at least the third layer comprising the third electrode material as discussed above.

The electrode may advantageously comprise at least the layers of a first layer comprising a first electrode material of formula Pr₍₁₋ₓ₎LnₓO_{(2-0.5x-δ)}, the third layer comprising the third electrode material as discussed above, and the second layer comprising a second electrode material as discussed above.

The layers of the electrode may be pressed, optionally isostatically pressed, during sintering to improve adhesion and other properties.

Usually, the electrode may be an air electrode in an electrochemical cell, for example a SOC, a SOFC or SOEC.

Thus, in a third aspect, the present invention accordingly provides an electrochemical cell comprising an electrode according to any one of the preceding claims; optionally further comprising one or more of an electrolyte, a second electrode and a substrate. The second electrode may be a second, fuel electrode.

The first electrode material, in contrast to some electrode materials, has excellent activity and other properties and does not need to contain alkaline earth metal oxides (e.g. strontium oxide). Alkaline earth metal oxides may be problematic in electrochemical cells because they may react, in particular, with zirconia-based electrolytes.

In a fourth aspect, the present invention accordingly provides an electrochemical cell comprising an electrode, the electrode having at least a first layer comprising a first electrode material of formula Pr₍₁₋ₓ₎LnₓO_{(2-0.5x-δ)}, wherein Ln is selected from at least one rare earth metal, δ is the degree of oxygen deficiency, and 0.01≤x≤0.4; and wherein the first layer comprising the first electrode material is directly in contact with a material comprising zirconia.

The material comprising zirconia may be a layer of the electrolyte in the electrochemical cell.

Thus, the electrochemical cell will usually further comprise an electrolyte and the material comprising zirconia may form a layer of the electrolyte.

The layer with the zirconia containing layer may be a or the main electrolyte layer or an interlayer (especially a thin interlayer) over another main electrolyte layer (that may, for example, comprise ceria). Thin zirconia electron-blocking layers may be applied in SOC as electrically insulating layers of the electrolyte because of some electrical conductivity of ceria-based electrolytes.

Thus, the material comprising zirconia may form a substantially electronically insulating layer of the electrolyte.

In known electrochemical cells, to avoid reaction between zirconia and alkaline earth metal oxides, a buffer (or protective) layer of doped ceria (e.g. CGO) between the air electrode and the zirconia layer is often deposited.

Avoiding the need for a buffer layer is greatly advantageous because it may significantly reduce the manufacturing cost of the cell and may also improve the quality of the final zirconia containing layer after processing, due to optionally lower processing temperature and fewer sintering/deposition steps in the cell as a whole.

The material comprising zirconia may be selected from scandia stabilised zirconia (ScSZ), yttria stabilised zirconia (YSZ), scandia ceria co-stabilised zirconia (ScCeSZ), ytterbia stabilised zirconia (YbSZ), scandia yttria co-stabilised zirconia (ScYSZ) and mixtures thereof.

The electrochemical cell may comprise a multi-layer electrolyte and so may further comprise an electrolyte layer comprising doped ceria, optionally selected from samarium-doped ceria (SDC), gadolinium-doped ceria (GDC or CGO), samaria-gadolinia doped ceria (SGDC) and mixtures thereof.

The electrochemical cell may further comprise a substrate; optionally a metallic substrate, preferably a steel substrate. The substrate may be porous.

Metal substrates may be a metallic foil (i.e. solid metal) in which openings are provided. That has an advantage that the porosity can be tailored and positioned in specific areas of the substrate. Alternatively or in addition, a metal substrate may have inherent porosity (e.g. isotropic porosity) formed for example as tape cast by powder depositing a film that is then sintered to form a porous substrate. References herein to metal substrates or a porous steel sheet may refer to either of these.

The electrochemical cell may be an electrolytic cell, an oxygen separator, a sensor or a fuel cell, or an electrolyser cell, preferably a SOFC.

Thus, the electrochemical cell may be a fuel cell, or an electrolyser cell. The cell may be based upon a solid oxide electrolyte, optionally a metal-supported solid oxide cell. In fuel cell mode, a fuel contacts the anode (fuel electrode) and an oxidant, such as air or an oxygen-rich fluid, contacts the cathode (air electrode), so in fuel cell mode operation, the air electrode will be the cathode. A solid oxide electrolyser cell (SOEC) may have the same structure as an SOFC, but is essentially the SOFC operating in reverse, or in a regenerative mode, to achieve the electrolysis of water and/or carbon dioxide by using the solid oxide electrolyte to produce hydrogen gas and/or carbon monoxide and oxygen.

In a fifth aspect, the present invention accordingly provides a method of producing an electrochemical cell, the method comprising providing a substrate, optionally having deposited thereon layers comprising a fuel electrode layer and an electrolyte, applying a source of Pr and Ln to the substrate (with or without the optional layers comprising a fuel electrode layer and one or more electrolyte layers) to form an air electrode layer, wherein Ln is selected from at least one rare earth metal, optionally drying, and optionally sintering the air electrode layer; thereby forming an air electrode.

Optionally, the method may further comprise, applying material to the substrate to form at least one electrolyte layer, applying the source of Pr and Ln on the electrolyte layer to form an air electrode layer, optionally drying, and co-sintering the electrolyte layer and the air electrode layer.

For example, the air electrode layer (e.g. the active air electrode layer, CAL) may be co-fired (i.e. co-sintered) with an underlying electrolyte material layer where both layers had been laid down sequentially as green layers (and optionally pressed). The at least one electrolyte layer (there may of course be other electrolyte layers) may be a layer comprising zirconia (e.g. an electron blocking layer). Co-sintering is greatly advantageous because it allows production with fewer steps.

In a sixth aspect, the present invention provides a material of formula Pr₍₁₋ₓ₎LnₓO_{(2-0.5x-δ)}, wherein Ln is selected from at least one rare earth metal, δ is the degree of oxygen deficiency, and 0.01≤x≤0.4.

In a seventh aspect, the present invention provides a material of formula Pr₍₁₋ₓ₎SmₓO_{(2-0.5x-δ)}, wherein δ is the degree of oxygen deficiency, and 0.01≤x≤0.4.

The method of making the material according to the sixth or seventh aspects of the invention may comprise:
(a) making a first solution comprising a soluble Pr-salt, preferably Pr-nitrate, and a soluble Ln-salt, preferably Ln-nitrate;
(b) mixing the first solution of (a) with a second solution which is capable of reacting with the salts of (a) to form an insoluble precipitate, wherein the insoluble precipitate may be thermally decomposed;
(c) calcining the insoluble precipitate to decompose the insoluble precipitate and generate the material according to the first aspect of the invention.

The method of forming an electrode comprising at least a first electrode layer may comprise the steps of providing a suitable dispersion in a carrier of the first electrode layer material, applying a coating of the dispersion to a substrate; and sintering the coating to form the air electrode.

Sintering may be performed at a temperature in the range 750° C. to 900° C., preferably from 800° C. to 870° C. Sintering may be performed in an air atmosphere.

### Definitions

In this specification, the terms “lanthanoid”, and “lanthanide” are used interchangeably and mean the metallic chemical elements with atomic numbers 57-71.

The term “dopant” as used herein is not intended to be restricted to a maximum percentage of elements, ions or compounds added to chemical structures. Similarly, the term “doping” is intended to mean the addition of a certain amount of elements, ions or compounds to a material. It is not limited to a maximum quantity of material, after which, further addition of material no longer constitutes doping.

The term “perovskite structure” as used herein refers to a single network of chemically bonded crystal structures which have a generally perovskite (ABX₃) structure. This does not mean that this single network need possess a single, uniform crystal structure throughout the entire structure. However, where different crystal structures occur between different regions of the network, it is often the case that these regions have complementary structures permitting chemical bonds to more easily form there between.

The term “solid oxide cell” (SOC) is intended to encompass both solid oxide fuel cells (SOFCs) and solid oxide electrolysis cells (SOECs).

The term “atomic percent” or “atomic percentage” (abbreviated herein to “at. %”) refers to the percentage of atoms with respect to a given dopant site.

The term “source of” an element, compound or other material refers to a material comprising the element, compound or other material whether or not chemically bonded in the source. The source of the element, compound or other material may be an elemental source (e.g. Ln, Sm, Pr or O₂) or may be in the form of a compound or mixture comprising the element, compound or other material including one or more of those elements, compounds or materials.

In this specification references to electrochemical cell, SOC, SOFC and SOEC may refer to tubular or planar cells. Electrochemical cell units may be tubular or planar in configuration. Planar fuel cell units may be arranged overlying one another in a stack arrangement, for example 100-200 fuel cell units in a stack, with the individual fuel cell units arranged electrically in series.

Electrochemical cells may be fuel cells, reversible fuel cells or electrolyser cells. Generally, these cells may have the same structure and reference to electrochemical cells may refer (unless the context suggests otherwise) to any of these types of cell.

“Oxidant electrode” or “air electrode” and “fuel electrode” are used herein and may be used interchangeably to refer to cathodes and anodes respectively of SOFCs because of potential confusion between fuel cells or electrolyser cells.

Although, in this specification, cells are described wherein the fuel electrode (e.g. an anode) is laid down first on the substrate, the invention also encompasses cells wherein the air electrode is laid down first on the substrate.

The cells described herein include metal supported cells where the layers of the cell are supported by a metallic substrate, but the invention also encompasses anode supported, electrolyte supported or cathode supported cells where the respective layer provides the structural support for all the other layers coated thereon.

Electrochemical cells as encompassed by the invention may comprise:
a) two planar components welded together with fluid volume in between (e.g. substrate with electrochemical layers and interconnecter (separate plate))
b) three planar components welded together with fluid volume in between (e.g. substrate with electrochemical layers and interconnecter (separate plate) and spacer providing fluid volume).

The various features of aspects of the disclosure as described herein may be used in combination with any other feature in the same or other aspect of the disclosure, if needed with appropriate modification, as would be understood by the person skilled in the art.

Furthermore, although all aspects of the invention or disclosure preferably “comprise” the features described in relation to that aspect, it is specifically envisaged that they may “consist” or “consist essentially” of those features outlined in the claims.

The invention will now be described with reference to accompanying figures and examples.

### BRIEF DESCRIPTION OF THE FIGURES

FIG. 1 illustrates a scanning electron micrograph (SEM) cross-section of a SOFC which includes an air electrode active layer (CAL) comprising a material according to the invention.

FIG. 2 illustrates x-ray diffraction (XRD) spectra (Cu K-α radiation) of Pr_{0.9}Gd_{0.1}O_{(1.95-δ)}.

FIG. 3 illustrates XRD spectra (Cu K-αradiation) of Pr_{0.8}Gd_{0.2}O_{(1.90-δ)}.

FIG. 4 illustrates XRD spectra (Cu K-αradiation) of Pr_{0.9}Sm_{0.1}O_{(1.95-δ)}.

FIG. 5 illustrates XRD spectra (Cu K-αradiation) of Pr_{0.85}Sm_{0.15}O_{(1.925-δ)}.

FIG. 6 illustrates XRD spectra (Cu K-αradiation) of Pr_{0.9}La_{0.1}O_{(1.95-δ)}.

FIG. 7 illustrates XRD spectra (Cu K-αradiation) of Pr_{0.8}La_{0.2}O_{(1.90-δ)}.

FIG. 8 illustrates XRD spectra (Cu K-αradiation) of Pr_{0.9}Yb_{0.1}O_{(1.95-δ)}.

FIG. 9 illustrates XRD spectra (Cu K-αradiation) of Pr_{0.8}Yb_{0.2}O_{(1.90-δ)}.

FIG. 10 illustrates XRD spectra (Cu K-αradiation) of undoped Pr₆O₁₁

FIG. 11 shows curves of the cubic lattice parameter calculated from XRD as a function of dopant and dopant level.

FIG. 12 shows curves of the normalised polarisation resistance as a function of temperature for cells in a 17-layer stack. A variety of air electrode variants is compared to a standard composite air electrode.

FIG. 13 shows curves of the normalised polarisation resistance as a function of temperature for cells in a 17-layer stack. A larger selection (than in FIG. 12) of various air electrode variants is compared to a standard composite air electrode.

FIG. 14 shows a box plot of the OCV of the cells in Example 6 compared to a standard cell at 570° C.

FIG. 15 shows the mean OCV of the cells of Example 6 as a function of temperature compared to standard cell and theoretical.

FIG. 16 shows a scanning electron micrograph (SEM) cross-section of the SOC according to Example 5

FIG. 17 shows a detail of a SEM cross section of the air electrode-electrolyte interface of the SOC according to Example 5

FIG. 18 shows a SEM cross-section of the air electrode-electrolyte interface of the SOC according to Example 6.

FIG. 19 shows the mean OCV of the cells of Example 7 compared to a standard cell at 570° C.

FIG. 20 shows a graph of polarisation resistance as a function of temperature for cells using a composite CAL as in Example 9 normalised to a standard cell with a PSC/CGO composite cathode active layer (standard cell =1.0).

FIG. 21(a) shows a scanning electron micrograph (SEM) cross-section at a first magnification of a SOC according to Example 9 with the cathode co-fired with the ceria interfacial layer.

FIG. 21(b) shows a scanning electron micrograph (SEM) cross-section at a second magnification of a SOC according to Example 9 with the cathode co-fired with the ceria interfacial layer.

FIG. 22 shows a scanning electron micrograph (SEM) cross-section of a SOC according to Example 9 with the cathode sintered separately to the ceria interfacial layer.

### DETAILED DESCRIPTION

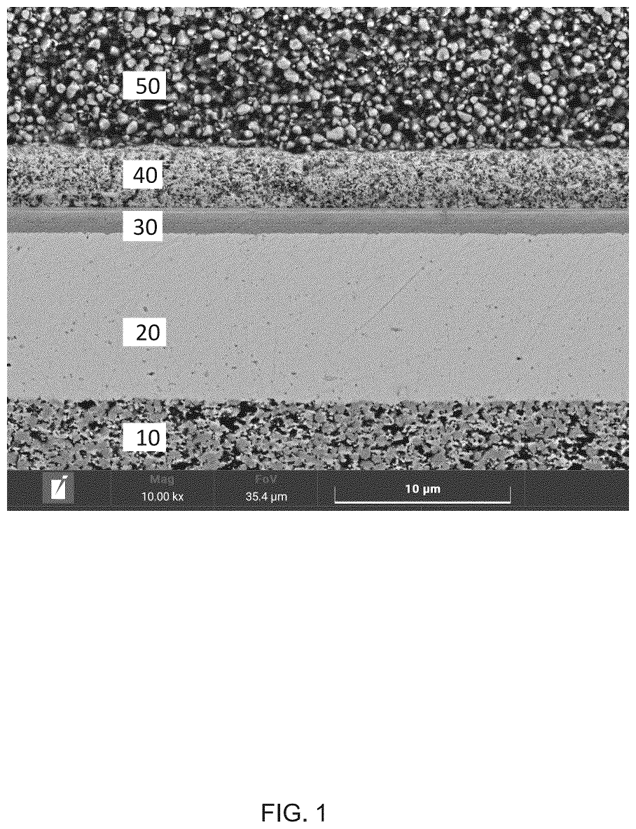

FIG. 1 illustrates an SOC comprising an anode (10), a doped ceria electrolyte layer (20), a zirconia layer (30), a PGO10 (Pr_{0.9}Gd_{0.1}O_{1.95-δ}) air electrode active layer, CAL, (40) and a perovskite air electrode bulk layer (50), CBL. Although not shown, the SOC in FIG. 1 may be deposited onto the surface of a metallic surface, such as metal, especially steel, more especially a ferritic stainless steel layer, usually a foil layer.

The CAL (40) comprises a material according to the invention. Anode (10), doped ceria interlayer (20), zirconia interlayer (30) and air electrode bulk layer (50) are layers of a type whose composition is known to the skilled person, as are methods of making and applying. Reference may, for example, be made to WO 2009/090419 A2, which discusses methods for laying down, as well as exemplary compositions of, layers of these types, together with the laying down of such layers upon a metal substrate, especially upon a stainless steel substrate. The layers (including air electrode layers) show good adhesion or may be isopressed to improve adhesion.

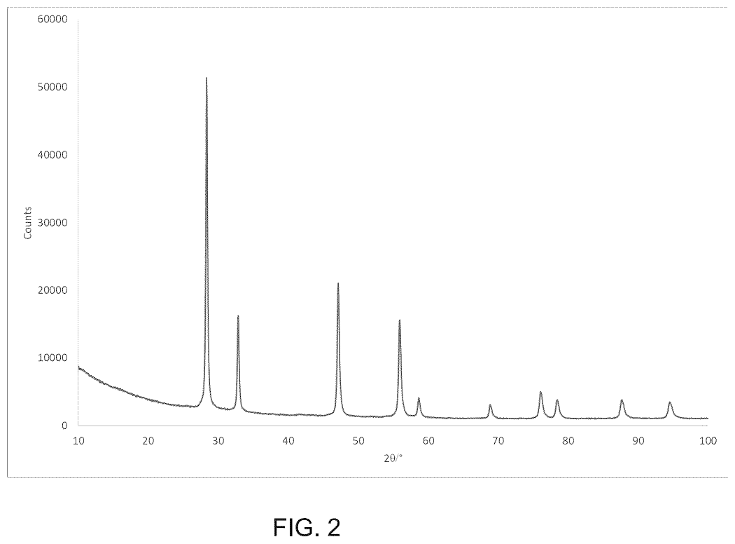

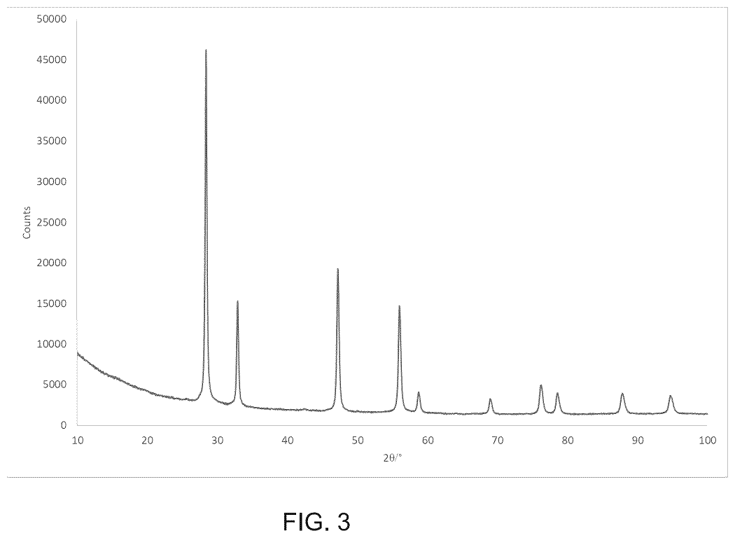

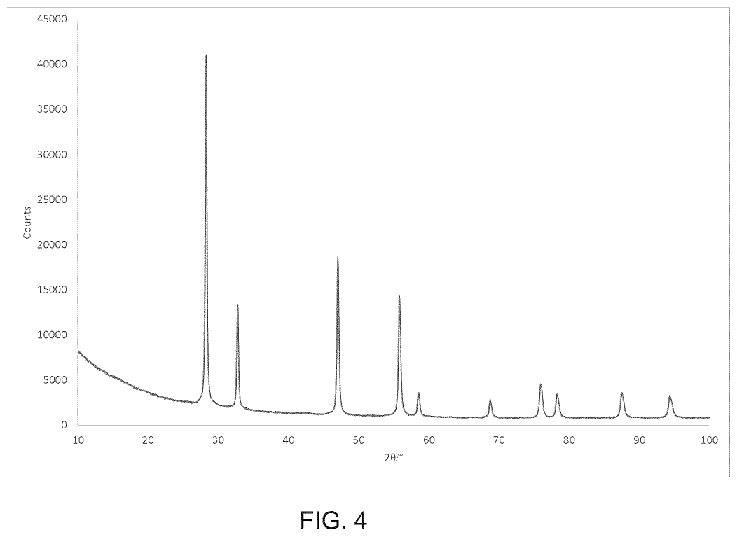

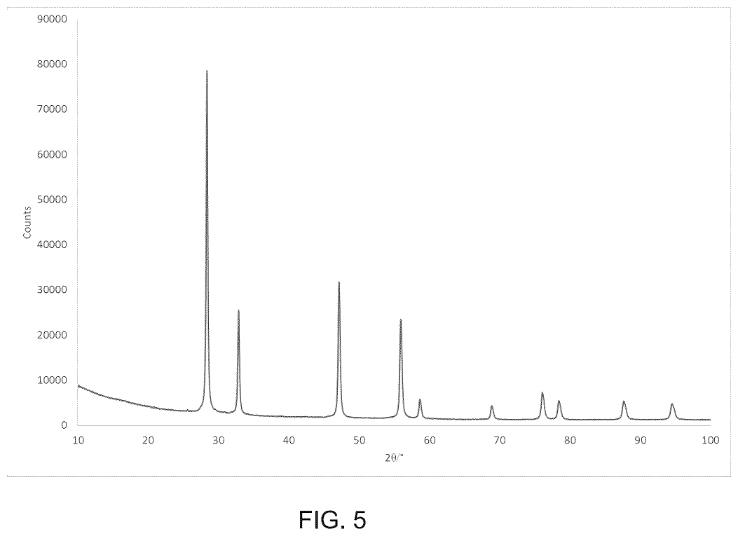

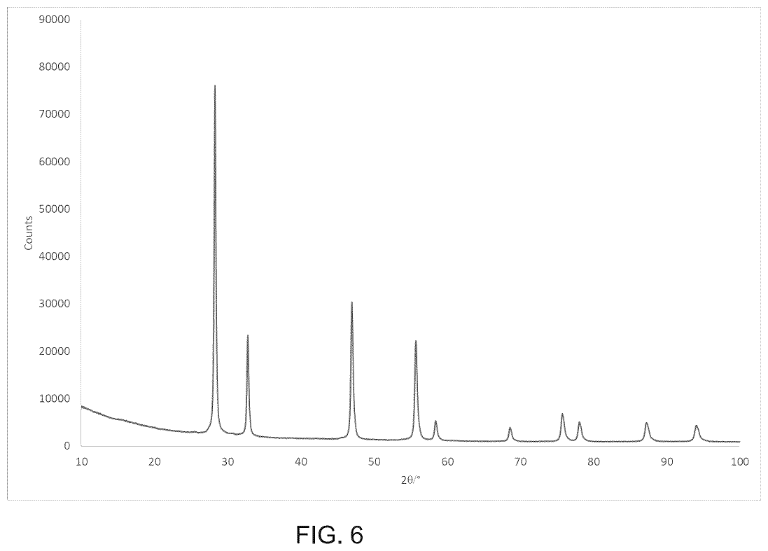

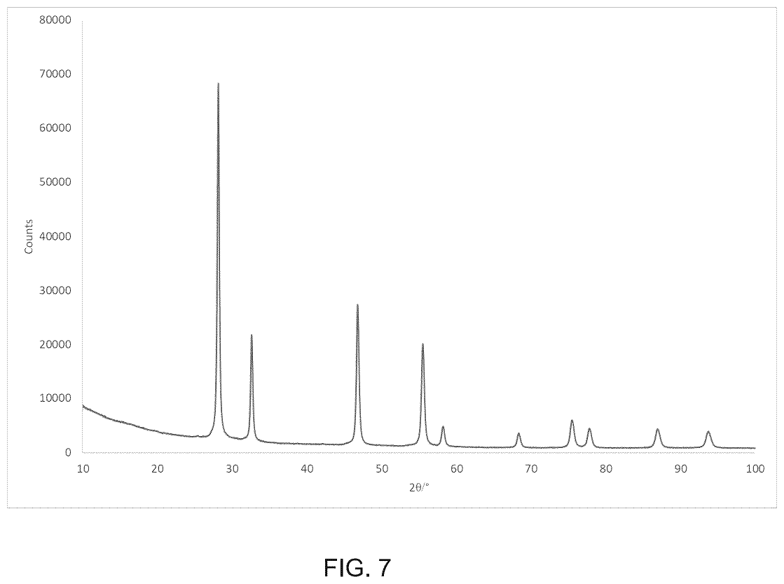

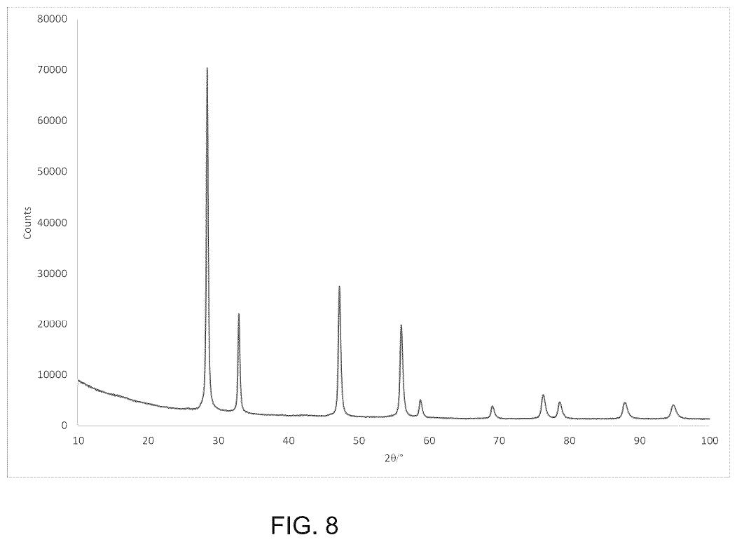

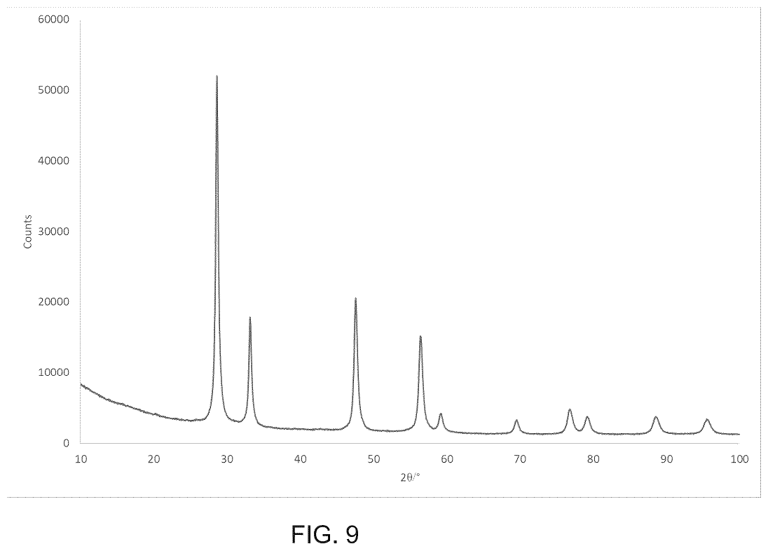

Materials according to the invention have been prepared, analysed and tested. FIGS. 2-9 illustrate XRD spectra (Cu K-αradiation) of the following materials according to the first aspect of the invention: Pr_{0.9}Gd_{0.1}O_{(1.95-δ)}, Pr_{0.8}Gd_{0.2}O_{(1.90-δ)}, Pr_{0.9}Sm_{0.1}O_{(1.95-δ)}, Pr_{0.85}Sm_{0.15}O_{(1.925-δ)}, Pr_{0.9}La_{0.1}O_{(1.95-δ)}, Pr_{0.8}La_{0.2}O_{(1.90-δ)}, Pr_{0.9}Yb_{0.1}O_{(1.95-δ)}, Pr_{0.8}Yb_{0.2}O_{(1.90-δ)}.

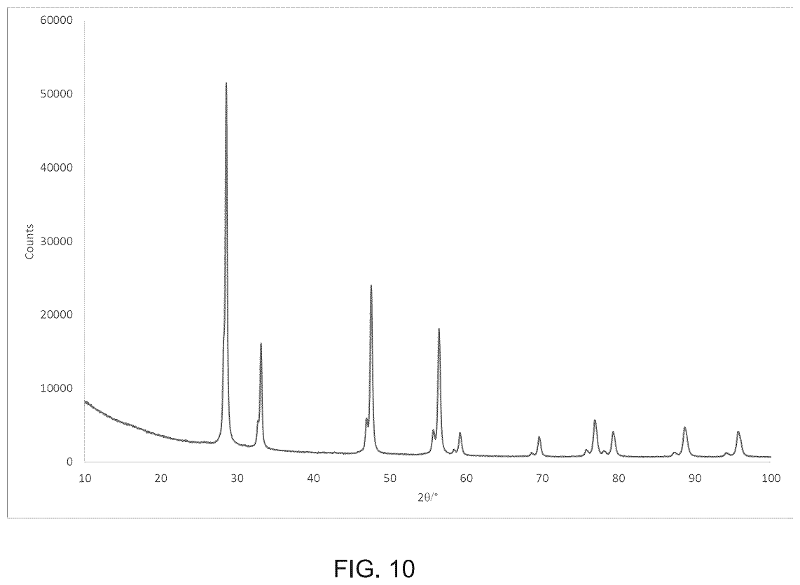

Each of these XRD spectra demonstrates the presence of a single-phase cubic fluorite structure. This is to be contrasted with the XRD spectra of FIG. 10 (XRD spectra (Cu K-αradiation) of undoped Pr₆O₁₁), which shows that the material has crystallised into two crystal phases, both of which have the same cubic fluorite structure, but with slightly different lattice parameters. The phase with the larger lattice parameter (and thus smaller diffraction angle for all the peaks) has a higher proportion of trivalent praseodymium. This information is derivable from the fact that each peak is not a single peak, as is the case in FIGS. 2-9, but a doublet, comprising two closely adjacent peaks. This phase instability is typical of Pr₆O₁₁, as mentioned above.

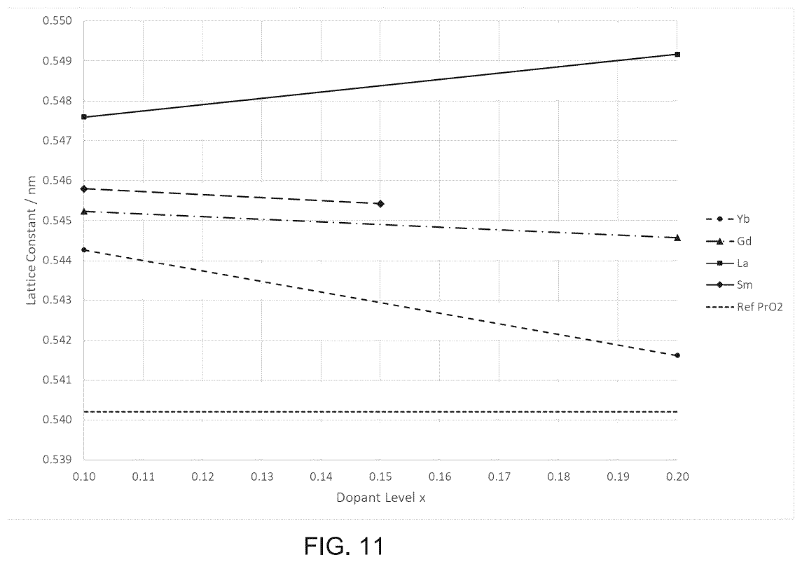

FIG. 11 shows curves of cubic lattice parameter calculated from XRD as a function of dopant and dopant level, with PrO₂ provided as a reference. As already explained, Pr³⁺ ions are larger than Pr⁴⁺ ions (113 picometres versus 110 pm). Since Pr₆O₁₁ comprises both of these ions in thermodynamic equilibrium, Pr₆O₁₁ has a larger lattice parameter than PrO₂. The effects observed in FIG. 11 are consistent with this. For example, as the undersized Yb³⁺ ion (ionic radius: 100.8 pm) is added, its presence counteracts the effect of the oversize Pr³⁺ ions and the lattice parameter decreases, tending towards the lattice parameter of pure PrO₂. Conversely, the presence of oversized La ions (ionic radius: 117 pm) causes an increase in lattice parameter with increasing dopant level. Doping with Gd and Sm ions has a lesser effect than doping with Yb and La ions, because the ionic radii of these materials (107.8 pm and 109.8 pm respectively) are closer to the ionic radius of Pr⁴⁺ (110 pm).

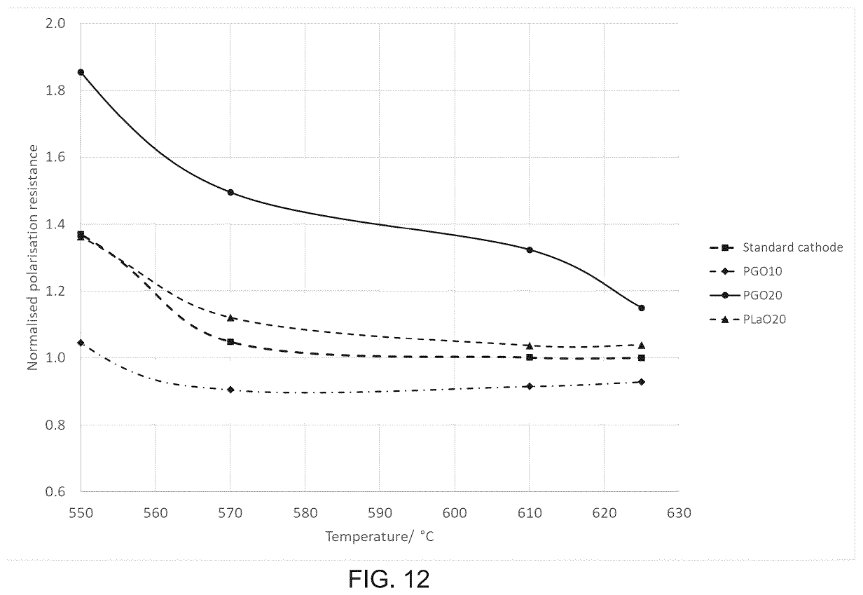

FIG. 12 shows curves of normalised polarisation resistance as a function of temperature for cells in a 17-layer stack with a variety of air electrode variants being compared to a standard composite air electrode (a rare earth strontium cobaltite/CGO composite with high catalytic activity), in which:
PG010 refers to Pr_{0.9}Gd_{0.1}O_{1.95-δ)}
PG020 refers to Pr_{0.8}Gd_{0.2}O_{1.90-δ)}
PLa010 refers to Pr_{0.9}La_{0.1}O_{1.95-δ)}
PLa020 refers to Pr_{0.8}La_{0.2}O_{1.90-δ)}

In order to measure polarisation resistance in an operating stack (being operated in SOFC mode in this instance), the stack was supplied with a fuel mixture simulating partially externally steam-reformed natural gas, at a flow rate such that 75% of the oxidisable fuel was consumed by the electrochemical reaction within the stack. Air was supplied to the air electrode side of the stack at a flow-rate well in excess of the stoichiometric requirement for oxygen, in order to minimise internal temperature gradients. There was a constant current density of 134 mAcm⁻². The stack temperature was varied by controlling the temperature of the furnace in which the test was being undertaken.

At each temperature, once the stack had reached thermal equilibrium, the impedance of all 17 cells was measured using AC impedance spectroscopy. This technique allows the internal cell impedance to be separated into ohmic (non-frequency variant) and non-ohmic components. The electrochemical impedance of the air electrode falls into the non-ohmic part of the impedance, hereafter described as polarisation resistance. It is not generally possible to separate the air electrode contribution from the fuel electrode in a complete fuel cell, so the polarisation resistance is that of the whole cell. The polarisation resistance is calculated based on the voltage drop from open-circuit minus the voltage drop attributed to ohmic resistance (which does not change much with applied current at a given temperature). The values quoted were normalised to those of cells with standard air electrodes at 625° C. and are all average values from at least three cells. As the fuel electrodes and external environment of the cells were all the same, any difference in polarisation resistance can be attributed to changes in the electrochemical activity of the air electrode for oxygen reduction. Any value less than 1 means the air electrode is more active for oxygen reduction than the standard air electrode.

These curves show that the four tested materials, which are all according to the present invention, function as an electrode (air electrode) material.

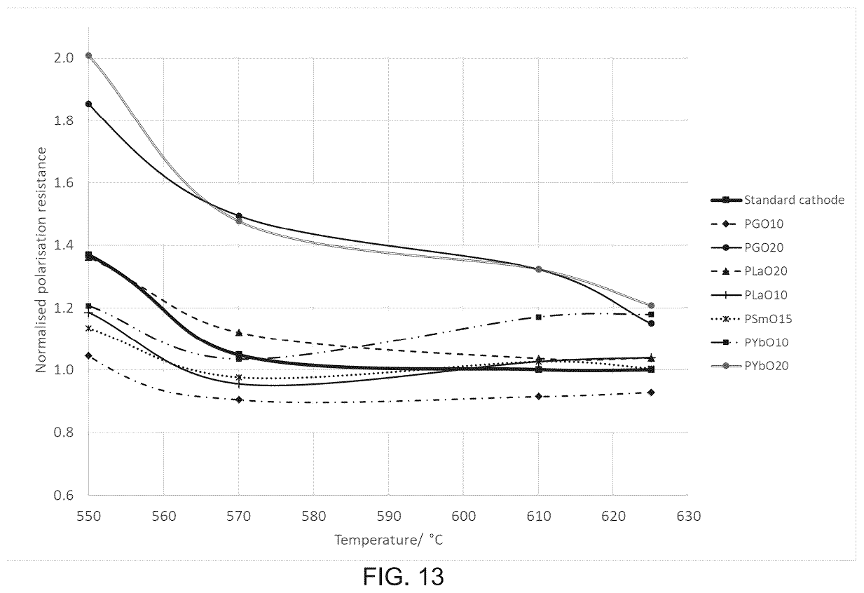

FIG. 13 shows curves of normalised polarisation resistance (measured in the same way as described above in relation to FIG. 12) as a function of temperature for cells in a 17-layer stack with a larger variety (than in FIG. 12) of air electrode variants being compared to a standard composite air electrode, in which:
PGO10 refers to Pr_{0.9}Gd_{0.1}O_{1.95-δ)}
PGO20 refers to Pr_{0.8}Gd_{0.2}O_{1.90-δ)}
PLaO10 refers to Pr_{0.9}La_{0.1}O_{1.95-δ)}
PLaO20 refers to Pr_{0.8}La_{0.2}O_{1.90-δ)}
PYbO10 refers to Pr_{0.9}Yb_{0.1}O_{1.95-δ)}
PYbO20 refers to Pr_{0.8}Yb_{0.2}O_{1.90-δ)}
PSmO15 refers to Pr_{0.85}Sm_{0.15}O_{1.925-δ)}

There follows in Examples 1-4 a general method for synthesizing doped praseodymia according to the invention (Example 1 and 2), synthesising a printable ink using such doped praseodymium powder (Example 3) and using such an ink to print a CAL (Example 4).

Example 5 relates to the use of an electrode layer according to the invention in a multi-layer air electrode system.

Example 6 relates to uses of an electrode layer according to the invention in direct contact with a scandia-yttria stabilised zirconia containing layer of an electrolyte system.

Example 7 relates to uses of an electrode layer according to the invention in direct contact with an ytterbia stabilised zirconia containing layer of an electrolyte system.

Example 8 relates to the use of a composite air electrode bulk layer.

### Example 1: Synthesis of Doped Praseodymium Oxide Powder

### Solution Preparation

A stoichiometric mixture of praseodymium nitrate hexahydrate and the desired dopant nitrate are dissolved in deionised (DI) water to give a solution molarity of 0.4M.

In a separate container under a fume hood, oxalic acid dihydrate is dissolved in the same volume of DI water used to dissolve the nitrates to give a molar ratio of oxalic acid to nitrates of 1.7 (slightly in excess of the stoichiometric requirement of 1.5 to ensure all the metal ions precipitate).

Once the oxalic acid fully dissolves, concentrated ammonium hydroxide solution is added whilst monitoring the pH, until the acid has been neutralised (pH 7) leaving a solution of ammonium oxalate.

### Precipitation

Whilst vigorously stirring the mixture, the solution of nitrates is added to the ammonium oxalate solution, resulting in a pale green precipitate of insoluble praseodymium plus dopant oxalate.

### Filtration

A Buchner funnel with a high-strength filter paper and aquarium pump is prepared. With the aquarium pump running, the precipitate mixture is poured onto the filter and sufficient time was allowed to pass until most of the supernatant solution has been removed, leaving a cake of precipitate on the filter paper.

### Washing

The precipitate is washed 3 times with DI water, then once with ethanol.

### Drying

The wet filter cake is transferred from the funnel to suitable containers and dried in a solvent-rated oven overnight at 70° C.

### Pulverisation

The dried precipitate cake is pulverised using a pestle and mortar, then the resulting powder is transferred to alumina crucibles.

### Calcination

The pulverized precipitate is transferred to alumina crucibles, which are placed in a gas-tight tube furnace, through which different gas mixtures can be fed. A water bubbler is provided in the gas exhaust line from the furnace, both to indicate that gas is flowing through the furnace and preventing back-flow of air into the furnace should the supply of gas be interrupted during cool-down.

A flow of a mixture of 5% H₂ in Ar is provided and it is ensured that gas was bubbling from the furnace exhaust. The furnace is heated to 710° C. at 5° C./min with a 1 hour dwell. The furnace is then cooled to <300° C. in a reducing atmosphere, then purged with nitrogen for 10 minutes.

A flow of air is provided to ensure that the finished material is the desired oxide phase. It is ensured that gas was bubbling from the furnace exhaust. The furnace is heated to 710° C. at 5° C./min with a 1-hour dwell. The furnace is then cooled to room temperature.

### Example 2: Alternative Synthesis of Doped Praseodymium Oxide Powder

### Solution Preparation

A stoichiometric mixture of praseodymium nitrate hexahydrate and the desired dopant nitrate are dissolved in deionised (DI) water to give a solution molarity of 0.15M.

In a separate container under a fume hood, concentrated ammonium hydroxide solution is diluted in DI water to give a 0.45M solution of the same volume as the nitrate solution.

### Precipitation

Whilst vigorously stirring the mixture, the solution of nitrates is added to the ammonium hydroxide solution, resulting in a pale green gelatinous precipitate of insoluble praseodymium plus dopant hydroxide.

### Filtration

A Buchner funnel with a high-strength filter paper and aquarium pump is prepared. With the aquarium pump running, the precipitate mixture is poured onto the filter and sufficient time was allowed to pass until most of the supernatant solution has been removed, leaving a cake of precipitate on the filter paper.

### Washing

The precipitate is washed 3 times with DI water, then once with ethanol.

### Drying

The wet filter cake is transferred from the funnel to suitable containers and dried in a solvent-rated oven overnight at 70° C.

### Pulverisation

The dried precipitate cake is pulverised using a pestle and mortar, then the resulting powder is transferred to alumina crucibles.

### Calcination

The pulverised precipitate is transferred to alumina crucibles, which are placed in a suitable furnace and heated in air to a temperature of 650° C. to decompose the hydroxide precipitate to the desired mixed oxide.

### Example 3: Synthesis of a Printable Ink

### Dispersal and Milling of Doped Praseodymium Oxide Powder

Doped praseodymium oxide powder, manufactured as discussed in Example 1 or 2, is weighed out and mixed with a carrier, a dispersant and an anti-foaming agent to form a slurry comprising a target amount of 46 wt % powder.

The slurry is transferred to a basket mill to which double the weight of slurry of 1 mm YSZ milling media are also added.

The slurry is milled at around 7000 rpm until a d₉₀<0.9 μm was achieved. The particle size distribution may be measured using a Malvern Mastersizer® 2000 laser diffraction particle size analyser.

The slurry is then removed from the basket mill.

### Ink Manufacture

The dispersed and milled praseodymium oxide powder slurry made in the preceding section is transferred to small high-shear disperser (HSD) pot and placed on the HSD.

Binder powder in an amount corresponding to 2.5-3.5 wt % of finished ink is weighed out.

The binder is added to slurry being actively dispersed on the HSD.

The ink is left on the HSD until the binder fully dissolves in the ink.

The ink is the transferred to a triple roll mill (TRM) for final homogenisation and passed through the mill four times with a front nip of 5 μm, ensuring the binder is fully homogenised into the ink and that no particles bigger than 5 μm remain in the finished ink.

### Example 4: Printing the Ink and Forming the Active Layer

The substrate in question comprised electrolyte layers deposited on a metal-supported SOFC. The ink was screen printed, using an automated screen printer, as a single pass onto the electrolyte layers of the metal-supported SOFC. It was then dried in a drying oven. The combination of ink solids content and screen mesh was chosen to give a thin print of approximately 3 μm. Following addition of a CBL, the layer was then sintered together with the CBL at a temperature from 820 to 870° C. to form the CAL. Following sintering, x-ray diffraction and BET analysis was repeated. Post-sintering, there was a slight increase in crystallite size and a reduction in BET surface area, but no change in the crystal structure. The layer still consisted of a single phase having a cubic fluorite structure.

### Example 5: Air Electrode Using a Layer of CAL of PrLnO and Further Layers

The first electrode material as described herein and exemplified in Examples 1 to 4 above, has equivalent or better performance than standard and is less susceptible to poisoning from airborne contaminants, particularly sulphur and water vapour in the air. In order to improve performance still further SOFC air electrodes consisting of three layers were produced. The three-layer electrode advantageously reduces the effect of chromium contamination (praseodymium oxide may react with chromia to form a perovskite) and ensures even better adhesion between the bulk layer and the active layer.

The three layers of the electrode were a bulk layer of LCN60 offering excellent stability and thermal expansion matching to the rest of the cell, an interfacial composite layer of rare-earth strontium cobaltite (or LSCF)/CGO and a catalytically active layer of rare-earth doped praseodymium oxide. The interfacial layer both ensures good adhesion between the active layer and the bulk and acts as a poison getter for the active layer as poisons such as chromium and sulphur will react with the rare earth strontium cobaltite/cobalt ferrite before getting to the strontium free active layer (which may be susceptible to chromium poisoning). The interfacial layer has a similar thermal coefficient to the air electrode bulk layer. This protects the active layer from degradation (which would not be affected by water vapour, carbon dioxide or sulphur dioxide)

The air electrode was produced by being screen printed as three layers, a thin layer (ca 3 microns) of the first electrode material (e.g. PSmO10), a thin layer (ca 3 microns) of rare earth strontium cobaltite/CGO (e.g. ReSC/CGO10 60:40; wherein “Re” refers to rare earth), and finally a much thicker (ca 40 microns) of bulk layer (LCN60).

Optionally these layers may be burnt out and isostatically or uniaxially pressed to enhance their green density, and then finally sintered in air at 800-850° C. to form the finished air electrode.

Generally, adherence may be improved without the need for isopressing the layer by printing 2 layers where the electrochemically active layer is PLnO, e.g. PGO10 or PSmO10, and on top of this an interfacial layer of PSC/CGO.

Air electrodes as described were provided in standard metal supported SOFCs and incorporated in 17 cell stacks. For each cell the anode was ceria-nickel cermet and the electrolyte comprised CGO with a doped zirconia electron blocking layer. As discussed in Example 5, below, the active layer may be directly in contact with the zirconia electron blocking layer or a layer of e.g. CGO may be interposed between the active layer and the zirconia electron blocking layer.

The stack was run with air flow on the air side and fuel of simulated steam-reformed natural gas on the fuel side for an elapsed time of 2.19 kh at a temperature of 570° C. (stack air outlet temperature) and a current of 17.81 A (227 mAcm⁻²), with 80% fuel utilisation (Uf), 20% air utilisation (Ua) and 1.5% water vapour in air.

The results are shown in Table 2 for voltage and ASR degradation rate over the elapsed time for a standard cell (as described above but with standard composite air electrode) and PSmO10 fired at 800° C. or 820° C. and either pressed (isopressing pressure at 300 MPa) or unpressed.

TABLE 2

| | Voltage | ASR |
|---|---|---|
| | degradation | degradation rate/ |
| | rate/% kh | mΩcm²/kh |
| Cell type | (1.5-2.2 kh) | (1.5-2.2 kh) |
| Standard cell | −0.31 | 16.0 |
| PSmO10 800° C. fire unpressed | −0.35 | 18.5 |
| PSmO10 800° C. fire pressed | −0.38 | 20.2 |
| PSmO10 820° C. fire unpressed | −0.19 | 9.8 |

The results show that all tested PSmO10 air electrode active layers (CALs) show low or very low degradation after 1.5kh and 2200 hours. The stacks went through several deep thermal cycles without significant performance change. The conclusion is that the air electrode according to the Example are excellent, showing excellent activity, adhesion and little susceptibility to contamination.

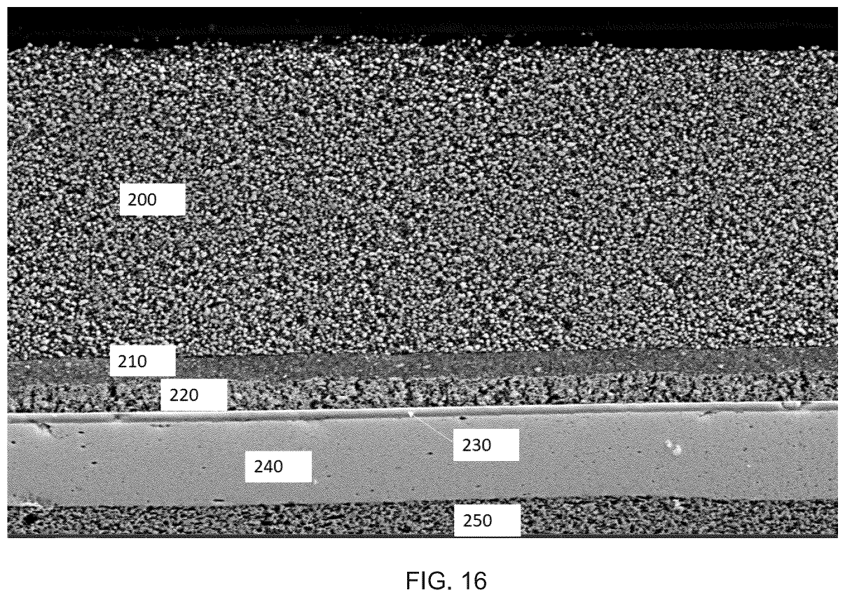

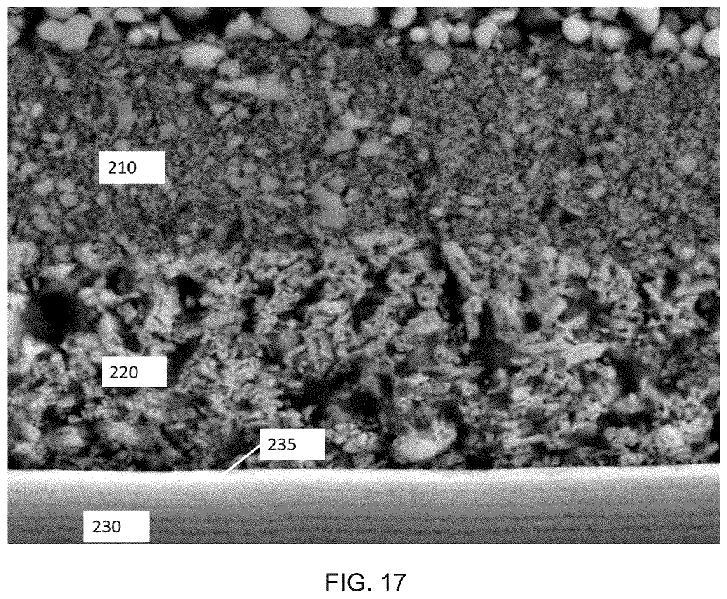

A cross section through the SOC of Example 5 is shown in FIG. 16 with a detail in FIG. 17. In FIGS. 16 and 17, the layers of the SOC are the bulk air electrode layer (CBL) 200, interfacial air electrode layer of ReSC/CGO 210, the air electrode active layer of PSmO10 (CAL) 220, the zirconia electron blocking layer 230, a doped ceria barrier layer 235, the electrolyte layer of doped ceria 240 and the fuel electrode 250. The fuel electrode is supported on the metallic substrate (not shown).

### Example 6. PrLnO Electrode Material in Direct Contact with Scandia-Yttria Stabilised Zirconia Containing Layer of Electrolyte

This Example investigates the performance of PrLnO CAL directly in contact with zirconia electron blocking layers in the electrolyte system.

The air electrode was produced by being screen printed on the electrolyte as three layers, a thin layer (ca 3 microns) of the first electrode material (e.g. PSmO10), a thin layer (ca 3 microns) of rare earth strontium cobaltite/CGO (e.g. ReSC/CGO10 60:40), and finally a much thicker (ca 40 microns) of bulk layer (LCN60).

Air electrodes as described were provided in standard metal supported SOFCs and incorporated in a stack. For each cell the anode was ceria-nickel cermet and the electrolyte comprised CGO with a scandia-yttria stabilised zirconia electron blocking layer.

Two types of cell were produced: Cell 1 had a doped ceria protective layer deposited directly on the zirconia electron blocking layer. Cell 2 had no doped ceria protective layer and so the CAL of PSmO10 was directly in contact with the zirconia electron blocking layer.

The cells were tested at open circuit with an air flow on the air side and fuel of 44% H₂ in N₂ on the fuel side at a temperature of 570° C.

The cells were compared to a standard cell.

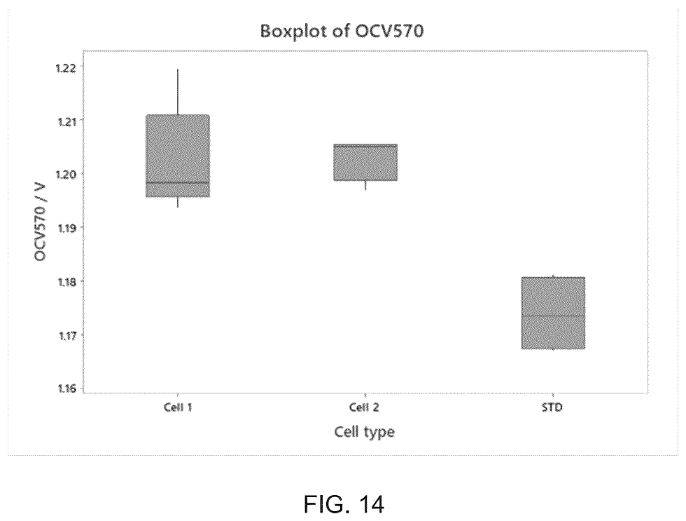

FIG. 14 shows a box plot of the Open Circuit Voltage (OCV) of the cells compared to the standard cell at 570° C.

All variants showed much higher OCVs than standard cells, with the cell 2 variant also showing little variation.

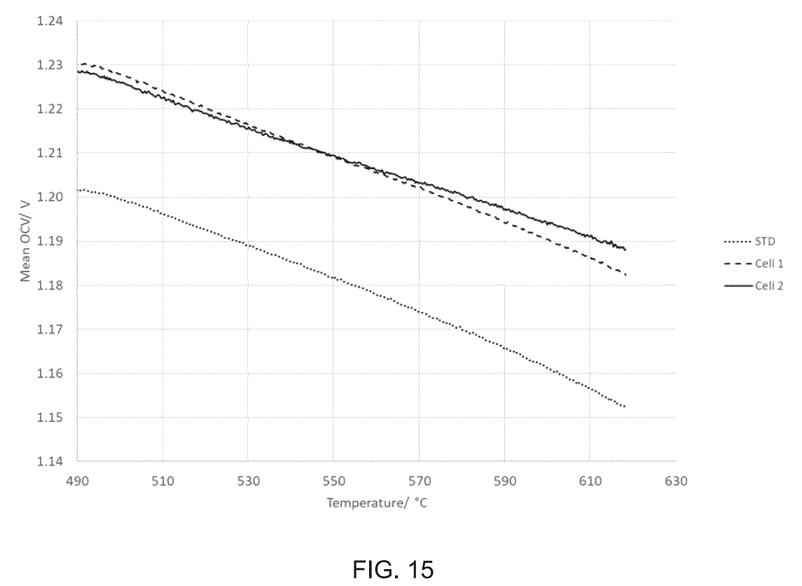

FIG. 15 shows the mean OCV of the cells as a function of temperature compared to standard cell. Each of the tested cells, Cell 1 and Cell 2 show good results. Cells with doped ceria layers (STD and cell 1) show accelerating trend of OCV decline with temperature whereas cell 2 results are reasonably linear.

The electrochemical performance of Cell 1 and Cell 2 were also assessed and found to be comparable to the standard cell, showing the omission of the doped ceria buffer layer in Cell 2 was not detrimental to performance.

The excellent results for the tested cells show that simplification of the cell design by removing the protective layer is possible. Thus, rare-earth doped praseodymia air electrode electrocatalysts e.g. PSmO10 may provide at least equivalent cell performance with the CAL deposited directly on the zirconia electron-blocking layer of the cell, avoiding the need for a doped-ceria barrier layer. It is unlikely that a non-conductive interfacial layer will form between these materials, as small levels of interdiffusion between zirconia and praseodymia is likely to result in ionically conductive phases on both sides of the interface. This has the potential to significantly reduce the manufacturing cost of the cell.

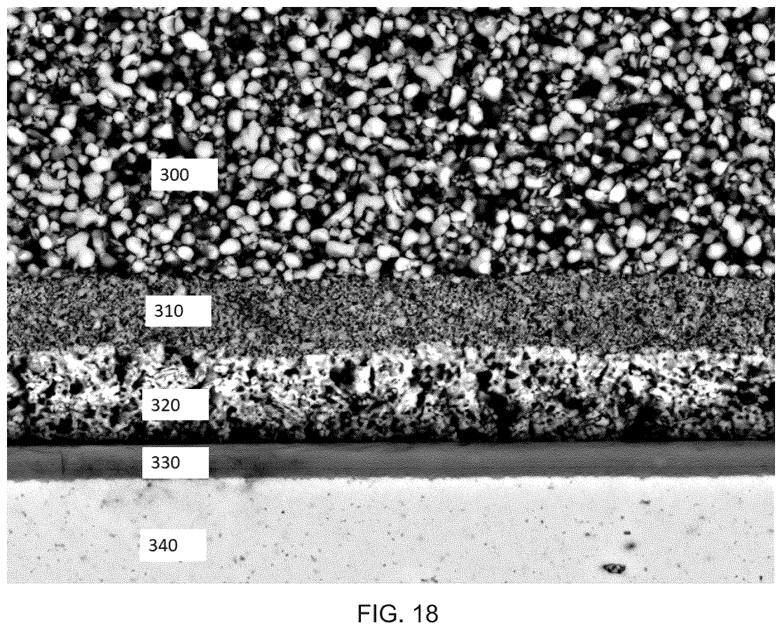

A cross section detail through the SOC of Example 6 is shown in FIG. 18 in which the layers of the SOC are the bulk air electrode layer 300, the interfacial air electrode layer of ReSC/CGO 310, the air electrode active layer of PSmO10 320, the zirconia electron blocking layer 330 and the electrolyte layer of doped ceria 340. The fuel electrode layer and substrate are not shown.

Other tests were conducted to evaluate co-sintering the doped zirconia containing layer of electrolyte and the PrLnO electrode material. Co-sintering would simplify production and lead to fewer sintering steps. The ScYSZ layer and PrLnO layer were deposited sequentially as green layers on the substrate and co-sintered at 800° C. to 850° C. (the layers may optionally be pressed). OCV results of the cell were acceptable.

### Example 7. PrLnO Electrode Material in Direct Contact with Ytterbia-Stabilised Zirconia Containing Layer of Electrolyte

This Example investigates the performance of PrLnO CAL directly in contact with zirconia electron blocking layers in the electrolyte system.

The air electrode was produced by being screen printed on the electrolyte as three layers, a thin layer (ca 3 microns) of the first electrode material (e.g. PSmO10), a thin layer (ca 3 microns) of rare earth strontium cobaltite/CGO (e.g. ReSC/CGO10 60:40), and finally a much thicker (ca 40 microns) of bulk layer (LCN60).

Air electrodes as described were provided in standard metal supported SOFCs and incorporated in a stack. For each cell the anode was ceria-nickel cermet and the electrolyte comprised CGO with an ytterbia-stabilised zirconia (YbSZ) electron blocking layer.

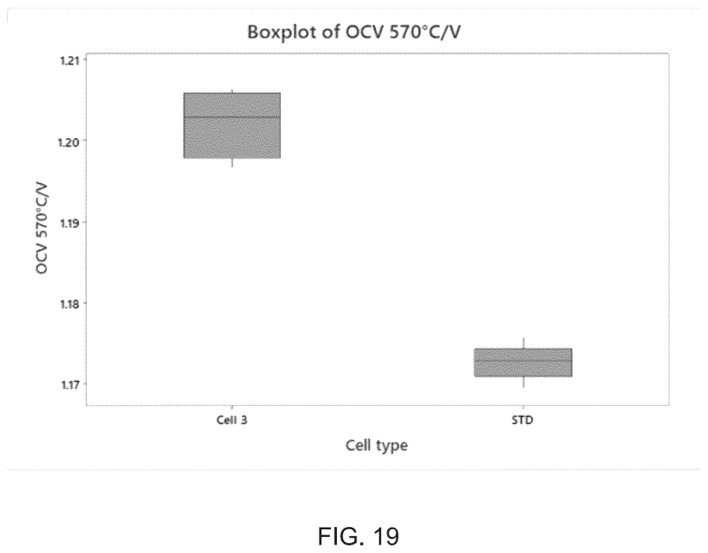

FIG. 19 shows a box plot of the Open Circuit Voltage (OCV) of the cells (described as Cell 3) compared to the standard cell at 570° C. It can be seen that as with Example 6 the OCVs of cells made according to this example are significantly higher than standard cells.

The electrochemical performance of Cell 3 was also assessed and found to be comparable to or in some conditions better than the standard cell, showing the omission of the doped ceria buffer layer was not detrimental to performance.

### Example 8. Two Layer Air Electrode of PLnO Active Air Electrode and Composite Bulk Air Electrode

A two layer air electrode of a first layer of PSmO10 and a second layer of a composite of 25 wt % PSC/75 wt % LCN60 without a buffer layer between the first and second layers was printed on to a cell of otherwise standard configuration as described in Example 5, above. The printed layer was then sintered to form a finished cell.

It was found that adhesion of the two layers in this instance was improved compared to a single component bulk cathode layer as illustrated in FIG. 1, and did not require isostatic pressing to achieve sufficient interfacial bonding.

### Example 9. Composite Cathode Active Layer of PSmO10/CGO10

Two types of cell were investigated, each with an air electrode produced by being screen printed as three layers, a thin layer of a first electrode composite material of PSmO10/CGO10 (60%: 40% by weight), a thin layer of rare earth strontium cobaltite/CGO (e.g. ReSC/CGO10 60:40; wherein “Re” refers to rare earth), and finally a much thicker bulk cathode layer (LCN60).

For each cell the anode was ceria-nickel cermet and the electrolyte comprised CGO with a doped zirconia electron blocking layer and an interfacial doped ceria layer on the zirconia blocking layer. The thin layer of the first electrode composite material was printed on the ceria layer.

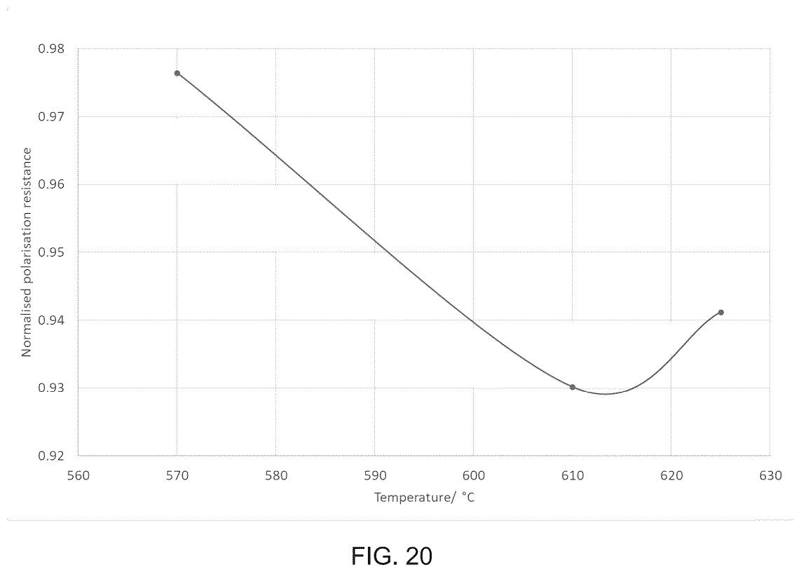

FIG. 20 shows a graph with test data from cells in 17-layer stack operating at 133 mAcm⁻² and 75% fuel utilisation. The graph shows polarisation resistance as a function of temperature normalised to a standard cell with a PSC/CGO composite cathode active layer (standard cell =1.0). The results show improved electrode performance (lower polarisation resistance) for PSmO10/CGO10 composite.

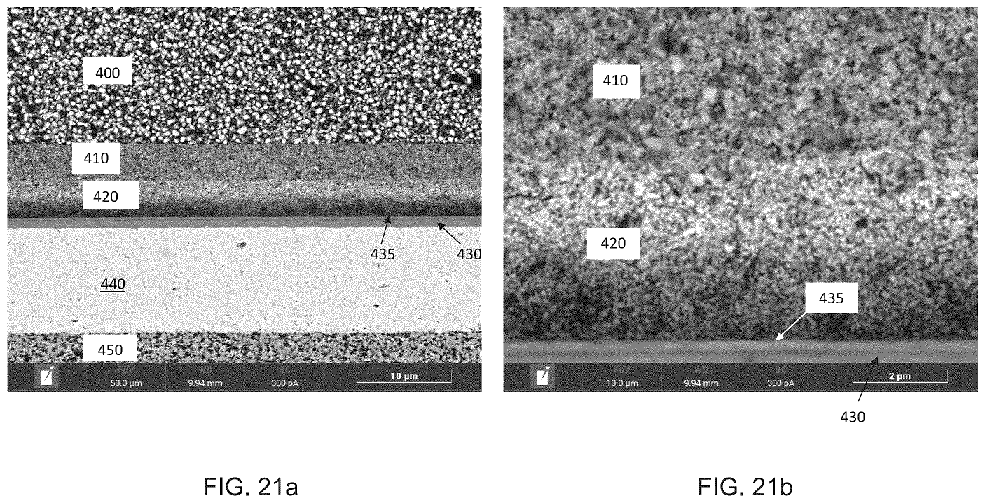

FIGS. 21(a) and (b) shows cross section SEM images at two magnifications of PSmO10-CGO (60:40) composite cathode active layer (CAL) and other layers of the stack, with the cathode co-fired with the ceria interfacial layer.

In FIGS. 21(a) and (b), the layers of the SOC are the bulk air electrode layer (CBL) 400, interfacial air electrode layer of ReSC/CGO 410, the air electrode active layer of PSmO10/CGO10 (60:40 wt %) (CAL) 420, a zirconia electron blocking layer 430, a doped ceria barrier layer 435, the electrolyte layer of doped ceria 440 and the fuel electrode 450. The fuel electrode 450 is supported on the metallic substrate (not shown).

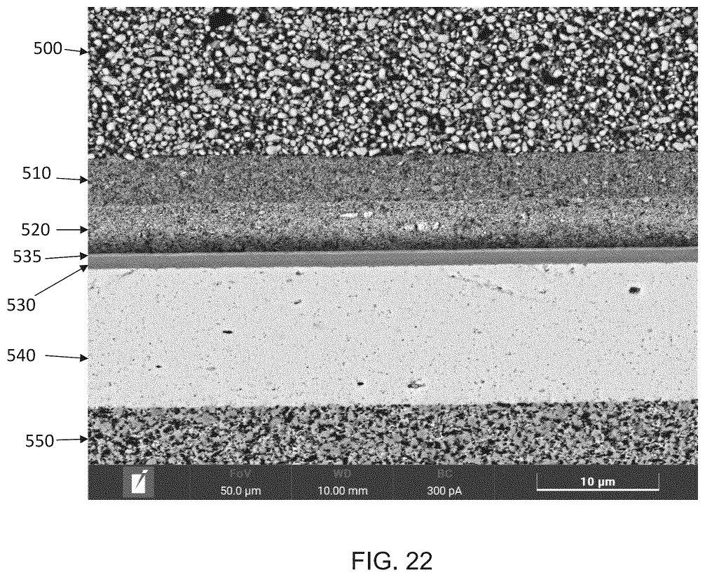

FIG. 22 shows a cross section SEM images of PSmO10-CGO (60:40) composite cathode active layer (CAL) and other layers of the stack, with the cathode sintered separately to the ceria interfacial layer.

In FIG. 22, the layers of the SOC are the bulk air electrode layer (CBL) 500, interfacial air electrode layer of ReSC/CGO 510, the air electrode active layer of PSmO10/CGO10 (60:40 wt %) (CAL) 520, a zirconia electron blocking layer 530, a doped ceria barrier layer 535, the electrolyte layer of doped ceria 540 and the fuel electrode 550. The fuel electrode 550 is supported on the metallic substrate (not shown).

In FIGS. 21 and 22, owing to the very similar density and morphology of the materials the two phases in the CAL have very little contrast under SEM imaging.

### REFERENCE NUMERALS

10—anode (fuel electrode)
20—electrolyte layer of doped ceria
30—electron blocking layer of zirconia
40—air electrode active layer (cathode active layer, CAL)
50—bulk cathode layer
200—Bulk air electrode layer (CBL)
210—Interfacial air electrode layer of ReSC/CGO
220—Air electrode active layer of PSmO10 (CAL)
230—Zirconia electron blocking layer with thin doped ceria barrier layer between zirconia and air electrode active layer
235—Thin doped ceria interfacial layer
240—Electrolyte layer of doped ceria
250—Fuel electrode
300—Bulk air electrode layer
310—Interfacial air electrode layer of ReSC/CGO
320—Air electrode active layer of PSmO10
330—Zirconia electron blocking layer
340—Electrolyte layer of doped ceria
400—Bulk air electrode layer
410—Interfacial air electrode layer of ReSC/CGO
420—Air electrode active composite layer of PSmO10/CGO
430—Zirconia electron blocking layer
435—Thin doped ceria barrier/interfacial layer
440—Electrolyte layer of doped ceria
450—Fuel electrode
500—Bulk air electrode layer
510—Interfacial air electrode layer of ReSC/CGO
520—Air electrode active composite layer of PSmO10/CGO
530—Zirconia electron blocking layer
535—Thin doped ceria barrier/interfacial layer
540—Electrolyte layer of doped ceria
550—Fuel electrode

All publications mentioned in the above specification are herein incorporated by reference. Although illustrative embodiments of the invention have been disclosed in detail herein, with reference to the accompanying drawings, it is understood that the invention is not limited to the precise embodiment and that various changes and modifications can be performed therein by one skilled in the art without departing from the scope of the invention as defined by the appended claims and their equivalents.

1. An electrode for an electrochemical cell, the electrode comprising at least a first layer comprising a first electrode material of formula Pr₍₁₋ₓ₎LnₓO_{(2-0.5x-δ)},
wherein Ln is selected from at least one rare earth metal,
δ is the degree of oxygen deficiency, and
0.01≤x≤0.4.

2. The electrode according to claim 1, wherein the rare earth metal is selected from a lanthanoid, Sc, Y and mixtures thereof.

3. (canceled)

4. (canceled)

5. The electrode according to claim 1, wherein 0.02≤x≤0.25.

6. (canceled)

7. The electrode according to claim 1, wherein the first layer comprises 20% by weight or greater of the first electrode material; optionally 30% by weight or greater of the first electrode material; optionally 40% by weight or greater of the first electrode material; optionally 55% by weight or greater of the first electrode material.

8. The electrode according to claim 1, wherein the first layer has a thickness in the range 1 μm to 7 μm.

9. The electrode according to claim 1, wherein the electrode comprises at least a second layer comprising a second electrode material.

10. (canceled)

11. The electrode according to claim 9, wherein the second electrode material is electrically conductive, optionally an electrically conductive ceramic material.

12. (canceled)

13. The electrode according to claim 9, wherein the second layer is a composite layer further comprising at least one additional second electrode material, optionally wherein the additional electrode material comprises a strontium containing material, optionally selected from rare earth strontium cobaltite; rare earth strontium ferrite, rare-earth strontium cobalt ferrite; wherein the rare earth component may optionally be Pr, La, Gd and/or Sm.

14. (canceled)

15. The electrode according to claim 13, wherein the second layer comprises 60% by weight or greater of the second electrode material; optionally 65% by weight or greater of the second electrode material; optionally 70% by weight or greater of the second electrode material; optionally 75% by weight or greater of the second electrode material.

16. The electrode according to claim 9, further comprising a third layer comprising a third electrode material, optionally situated between the first layer and the second layer.

17. (canceled)

18. (canceled)

19. The electrode according to claim 1, wherein the electrode is an air electrode.

20. The electrochemical cell comprising an electrode according to claim 1; optionally further comprising one or more of an electrolyte, a second fuel electrode and a substrate.

21. The electrochemical cell according to claim 20,
wherein the first layer comprising the first electrode material is directly in contact with a material comprising zirconia.

22. The electrochemical cell according to claim 21, further comprising an electrolyte and wherein the material comprising zirconia forms a layer of the electrolyte.

23. (canceled)

24. The electrochemical cell according to claim 21, further comprising an electrolyte layer further comprising doped ceria, optionally selected from samarium-doped ceria (SDC), gadolinium-doped ceria (GDC), praseodymium doped ceria (PDC), samaria-gadolinia doped ceria (SGDC) and mixtures thereof.

25. (canceled)

26. The electrochemical cell according to claim 20, wherein the electrochemical cell is an electrolytic cell, an oxygen separator, a sensor or a fuel cell, and optionally, wherein the electrochemical cell comprises a solid oxide electrochemical cell.

27. A method comprising:
providing a substrate, optionally having deposited thereon layers comprising a fuel electrode and an electrolyte,
applying a source of Pr and Ln to the substrate to form an air electrode layer, wherein Ln is selected from at least one rare earth metal,
optionally drying, and
optionally sintering the air electrode layer;
thereby forming the electrode according to claim 1.

28. A method as claimed in claim 27, wherein the method further comprises
applying material to the substrate to form at least one electrolyte layer,
applying the source of Pr and Ln on the electrolyte layer to form an air electrode layer,
optionally drying, and
co-sintering the electrolyte layer and the air electrode layer.

29. A material of formula Pr₍₁₋ₓ₎LnₓO_{(2-0.5x-δ)},
wherein Ln is selected from at least one rare earth metal,
δ is the degree of oxygen deficiency, and
0.01≤x≤0.4.

30. (canceled)

31. The material according to claim 29, wherein Ln is Sm.
